(19) United States
(12) Patent Application Publication
(10) Pub. No.: US 2019/0369850 A1
(43) Pub. Date: Dec. 5, 2019

(54) VIRTUAL REALITY USER INTERFACES FOR NETWORK DEVICES

(71) Applicant: Hewlett Packard Enterprise Development LP, Houston, TX (US)

(72) Inventors: Tathagata Roy, Bangalore (IN); Siddhartha Shankar Sahoo, Bangalore (IN)

(21) Appl. No.: 16/108,866

(22) Filed: Aug. 22, 2018

(30) Foreign Application Priority Data
May 30, 2018 (IN) 201841020339

(51) Int. Cl. G06F 3/0484; G06T 11/60; G06F 3/01; G06F 3/16

(52) U.S. Cl. CPC G06F 3/04847; G06T 11/60; G06T 2200/24; G06F 3/167; G06F 3/017; G06F 3/013

(57) ABSTRACT

In example implementations, an apparatus is provided. The apparatus includes a memory, a network device monitor, a virtual reality (VR) graphical user interface (GUI) generator, a communication interface, and a processor. The memory is to store network device information and physical location information. The network device monitor is to monitor a performance of network devices. The VR GUI generator is to generate a VR GUI of a physical location that includes the network devices based on the physical location information and the network device information. The communication interface is to transmit the VR GUI to the VR system. The processor is communicatively coupled to the memory, the network device monitor, the VR GUI generator, and the communication interface. The processor provides the network device information via the communication interface to be displayed on the VR GUI in response to a non-click input received from the VR system.

### CROSS REFERENCE TO RELATED APPLICATIONS

This application claims priority under 35 U.S.C. § 119(a)-(d) to Indian Patent Application Serial Mo. 201841020339, filed on May 30, 2018 in the Indian Intellectual Property Office.

### BACKGROUND

Network management systems (NMSs) allow companies or technicians to manage a variety of different network devices. A large enterprise may include thousands of network devices across a variety of different buildings and geographic locations. The NMSs may provide a database of all of the network devices and associated network device information. The NMSs generally provide a directory structure where a technician may click through a series of menus to obtain desired network device information.

### BRIEF DESCRIPTION OF THE DRAWINGS

FIG. 1 is a block diagram of an example system including a network management system (NMS) and a virtual reality (VR) system of the present disclosure;

FIG. 2 is a block diagram of the NMS server of the present disclosure;

FIG. 3 is an example of a virtual reality (VR) graphical user interface (GUI) of the present disclosure;

FIG. 4 is another example of the VR GUI of the present disclosure; and

FIG. 5 is a block diagram of an example non-transitory computer readable storage medium storing instructions executed by a processor.

### DETAILED DESCRIPTION

Examples described herein provide a virtual reality (VR) graphical user interface (GUI) and an apparatus for providing the same. The VR GUI may provide a more efficient interface for troubleshooting malfunctioning network devices that are managed by an NMS. As noted above, traditional NMSs may provide a directory tree structure where a technician may click through a series of menus to obtain desired network device information. The technician may have some knowledge of the NMS system, which files to select, and so forth, to find the desired network device information.

In addition, when troubleshooting a network device malfunction the technician may jump back and forth between different screens and menus in the NMS to obtain the desired network device information. The technician may have to remember the information from multiple screens as an amount of area to display information on a physical monitor may be limited. This can be a cumbersome and inefficient process to troubleshoot malfunctioning network devices.

Examples of the present disclosure provide a VR GUI that can provide a more efficient GUI for troubleshooting malfunctioning network devices. The VR GUI may show an exact physical representation of the location at which the network devices are located. The exact physical representation may include physical structures and non-network devices overlaid on a floor plan that corresponds to the coverage area of a network that NMS manages. The features of the physical structures and information about the non-network devices within the proximity to a malfunctioning network device can provide context that may help a technician to troubleshoot the malfunctioning network device that may not otherwise be seen through isolated data about the network device presented on a computer monitor.

The VR GUI of the present disclosure may also allow a technician to easily troubleshoot a malfunctioning network device without any clicks and without any a priori knowledge about how to use the VR GUI. For example, the VR GUI may monitor network devices based on any desired performance parameter. The VR GUI may communicate with, and work in coordination with, an NMS. The NMS may monitor the performance of the network devices and any malfunctioning or underperforming devices may be color coded differently from properly functioning network devices. Thus, the technician or user may easily identify the malfunctioning device in the VR GUI.

The technician may focus on the malfunctioning network device and the VR GUI may detect the focus on the network device and automatically display all of the associated network device information. Notably, the VR GUI may have unlimited space to display all of the information unlike a physical computer monitor. In addition, the information may be presented simultaneously rather than requiring a technician to click through several different user interface screens of the NMS, different menus, and/or different file directories, or scroll through large amounts of information due to the limited size of a display, to obtain the information. Thus, the VR GUI of the present disclosure may help to improve the efficiency of troubleshooting malfunctioning or underperforming network devices in an NMS.

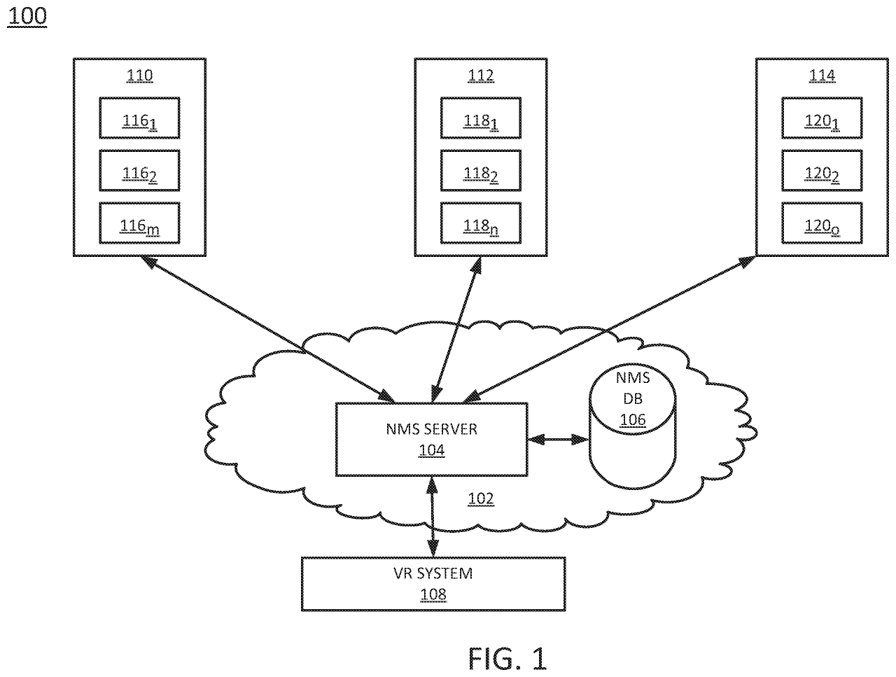

FIG. 1 illustrates an example system 100 of the present disclosure. In one example, the system 100 may include an Internet protocol (IP) network 102. It should be noted that the IP network 102 has been simplified for ease of explanation. The IP network 102 may include additional devices that are not shown. For example, the IP network 102 may include switches, firewalls, access points, access networks, and the like.

The IP network 102 may include a NMS server 104 and an NMS database (DB) 106). The NMS server 104 may be in communication with a plurality of different campus and/or branch locations 110, 112, and 114 via the IP network 102 that the NMS server 104 may monitor and manage. The NMS server 104 may also be in communication with a virtual reality (VR) system 108 via the IP network 102.

In one example, the locations 110, 112, and 114 may be different indoor or outdoor enterprise locations, campuses or branches, buildings, geographic locations, and the like. Although only three locations 110, 112, and 114 are illustrated in FIG. 1, it should be noted that the NMS server 104 may be in communication with any number of locations.

Each one of the locations 110, 112, and 114 may have various network devices that are managed and monitored by the NMS server 104. For example, the location 110 may have network devices 116₁-116ₘ (hereinafter referred to individually as a network device 116 or collectively as network devices 116), the location 112 may have network devices 118₁-118ₙ (hereinafter referred to individually as a network device 118 or collectively as network devices 118), and the location 114 may have network devices 120₁-120₀(hereinafter referred to individually as a network device 120 or collectively as network devices 120). The network devices 116, 118, and 120 may be access points, switches, routers, servers, endpoint devices (e.g., computers or mobile client devices), and the like.

In one example, information associated with each one of the network devices 116, 118, and 120 may be stored in the NMS DB 106. For example, the network device information may include an identification of the network device (e.g., a media access control (MAC) address, a host name, a manufacture identification number, and the like), a location, port information (e.g., connected port numbers, active port numbers, port connection information), configuration parameters associated with the network device, activity logs, and the like.

As noted above, the NMS server 104 may manage and monitor the network devices 116, 118, and 120 from a remote and/or central location. The NMS server 104 may manage the network devices 116, 118, and 120 by remotely making configuration changes and monitor the network devices 116, 118, and 120 by detecting when a network device is malfunctioning or underperforming.

Previously, a technician may be trained to obtain specialized knowledge of how the NMS server 104 operates. For example, the NMS server 104 may have a user interface that includes a series of different user interface screens, file directories, and/or menus. The technician may be trained to know where various types of network device information is located and click through a series of user interface screens. The network device information may be located in different user interface screens. As a result, the technician may have to remember network device information from different screens and menus as the technician collects information about a network device 116, 118, or 120.

In addition, when the technician finds the correct user interface screen in the NMS, the screen may contain large amounts of information. However, the size of the monitor or display may limit the amount of information that can be displayed. Thus, the technician may have to scroll up and down on the user interface screen to gather the desired information. Consequently, when a network device 116, 118, or 120 fails or underperforms, troubleshooting a particular network device can be a cumbersome and inefficient process using the user interface of the NMS server 104 alone.

The present disclosure provides a VR GUI generated by the NMS server 104 that is transmitted to the VR system 108. The VR system 108 may include a VR processor and a VR display. In some examples, the VR processor the VR display may be combined into a single head mounted display or deployed as separate components. The VR display may display the VR GUI and allow a user to interact with the VR GUI using hand gestures and retinal focus to select or view items in the VR GUI. The VR system 108 may also include a joystick to control movement through the different locations and areas presented by the VR GUI, as discussed herein. The VR GUI provides an intuitive interface that does not require any a priori knowledge of the interface and a click free interface. The VR GUI can quickly display an identified network device that is malfunctioning and provide all of the information associated with the malfunctioning network device.

In one example, the VR GUI may be displayed in a web-based VR. For example, rather than the VR system 108, a user may have a web-based VR with a joystick or mouse to allow interaction with the VR GUI in a “click-free” manner in a same way a user may interact with the VR GUI via the VR system 108.

The VR GUI can provide an exact replica of the locations 110, 112, and 114 including nearby non-network devices or physical structures within the proximity of the malfunctioning network device. The technician may travel within the location 110, 112, and/or 114 presented in the VR GUI and view the associated network devices 116, 118, and 120 and the non-network devices or physical structures as if the technician were in the actual locations 110, 112, and/or 114. Specifically, the technician may navigate around the floor plan in the VR GUI through a joystick, hand gestures, eye movements, and/or any other proximity sensing technology inputs.

The non-network devices or physical structures may provide visual context of the network devices 116, 118 and 120 to help improve troubleshooting efficiency. For example, a network device 116 may be near an air conditioning vent or a wall that is inhibiting performance of the network device 116. This type of information may not be available to the NMS server 104 without the VR GUI. Thus, the VR GUI can allow a technician to more efficiently troubleshoot a malfunctioning network device.

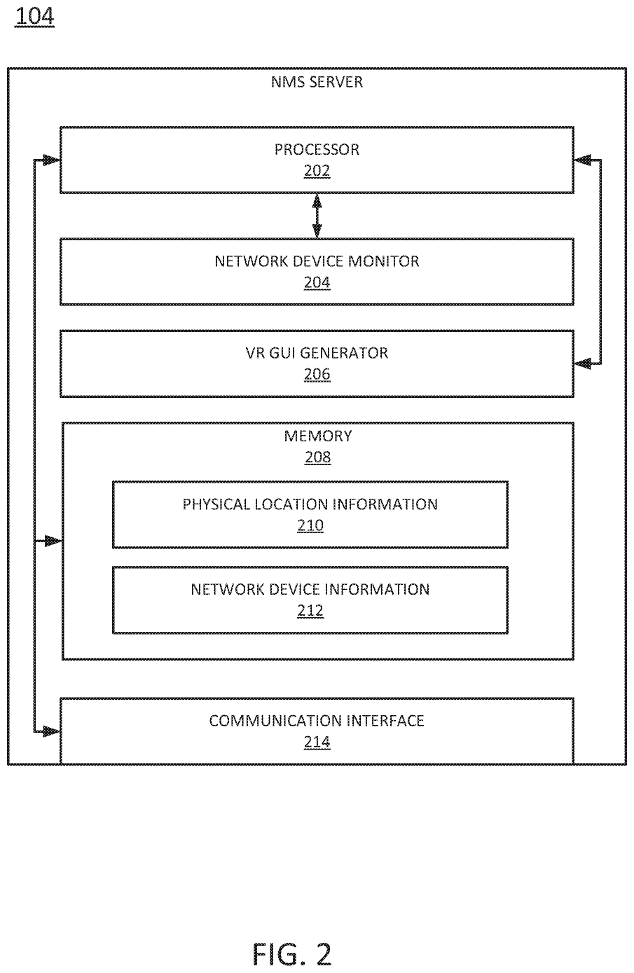

FIG. 2 illustrates a block diagram of an example NMS server 104. In one example, the NMS server 104 may include a processor 202, a network device monitor 204, a VR GUI generator 206, a memory 208, and a communication interface 214. The processor 202 may be communicatively coupled to the network device monitor 204, the VR GUI generator 206, the memory 208, and the communication interface 214. The processor 202 may execute instructions stored in the memory 208 to execute the functions described herein. The memory 208 may be any type of non-transitory computer readable storage medium. The memory 208 may be internal to the NMS server 104 or may be external to the NMS server 104 (e.g., deployed as the NMS DB 106). The memory 208 may be deployed as different memory devices (e.g., a combination of hard disk drive memory, random access memory (RAM), the NMS DB 106, and the like).

In one example, the network device monitor 204 may collect performance data from the network devices 116, 118, and 120. The performance data may be compared to a predefined value of a performance parameter. For example, packet throughput rates of a router may be measured and provided to the network device monitor 204. The packet throughput rates may be compared to a threshold for the packet throughput rate. When the packet throughput rate of the router falls below the threshold, the router may be identified as malfunctioning or underperforming.

In another example, the network device monitor 204 may monitor an operation status of the network devices 116, 118, and 120. For example, the performance parameter may simply be operation of a network device. When a network device stops operating for whatever reason (e.g., software error, power outage, and the like), the network device monitor 204 may identify the network device as malfunctioning. It should be noted that a few examples have been provided, but the network device monitor 204 may monitor the network devices 116, 118, and 120 for any type performance parameter.

In one example, the VR GUI generator 206 may generate the VR GUI that is seen by the VR system 108. The VR GUI may be generated based on physical location information 210 and the network device information 212 stored in the memory 208. Although the VR GUI generator 206 is illustrated as being implemented in the NMS server 104, it should be noted that the VR GUI generator 206 may be located in an application layer outside of the NMS server 104 and located in an another computing system between the NMS server 104 and the VR system 108. Moving the VR GUI generator 206 from the NMS server 104 may reduce the processing burden on the NMS server 104.

In one example, each one of the locations 110, 112, and 114 may have physical location information 210 stored in the memory 208. The physical location information 210 may be provided during an initialization. For example, the physical location information 210 may be obtained from static floorplans. In another example, the physical location information 210 may be obtained via triangulation performed by devices installed at the respective locations 110, 112, and 114. For example, the devices may emit a beacon and measure a location (e.g., xy coordinates) of the respective network devices 116, 118, and 120 and structural information based on triangulation measurements of the emitted beacons.

For example, all of the dimensions, structural information, and the like associated with the locations 110, 112, and 114 may be stored in the memory 208. The physical structures or non-network device information may provide positional context of the network devices 116, 118, and 120 in the physical locations 110, 112, and 114. As changes to a physical location 110, 112, and 114 are made, the associated physical location information 210 may be periodically updated.

The network device information 212 may include the network device information, discussed above, for each physical location information 210. For example, the dimensions and structural information associated with the location 110 may be stored in the physical location information 210. The network device information associated with the network devices 116 and the actual placement of the network devices 116 in the location 110 may be stored in the network device information 212.

The VR GUI generator 206 may then generate a VR GUI based on the physical location information 210 and the network device information 212 to generate an exact replica of the location 110. The VR GUI may be generated for a particular building, a particular floor, a particular room, and the like associated with the location 110.

In one example, the VR GUIs may be generated in advance by the VR GUI generator and stored in the memory 208. A VR GUI may be generated for each location 110, 112, and 114. The locations 110, 112, and 114 (and/or each particular building, room, or floor) may be tagged and associated with one of the VR GUIs. Thus, a non-click input, such as a voice command, may be provided to view a particular location via the VR system 108. In one example, the VR system 108 may use a natural language processing (NLP) application to translate and execute the voice commands.

For example, a VR GUI may be generated for office 1300 on the 13th floor of building A at location 110 (e.g., Phoenix, Ariz.). A user may use a voice command indicating that the user would like to view office 1300 on the 13th floor of building A in Phoenix, Ariz. As a result, the NMS server 104 may transmit the VR GUI to the VR system 108 that provides an exact replica of office 1300 on the 13th floor of building A in Phoenix, Ariz.

In one example, the VR GUI may be transmitted to the VR system 108 via the communication interface 214. For example, the NMS server 104 may establish a wireless or wired connection to the VR system 108 via the communication interface 214 and transmit data over the IP network 102.

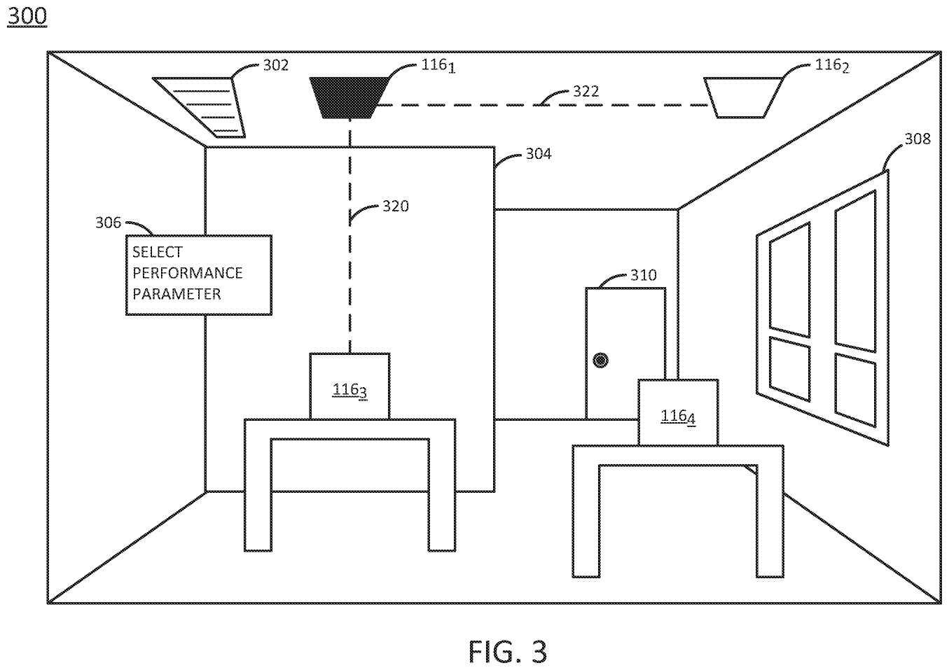

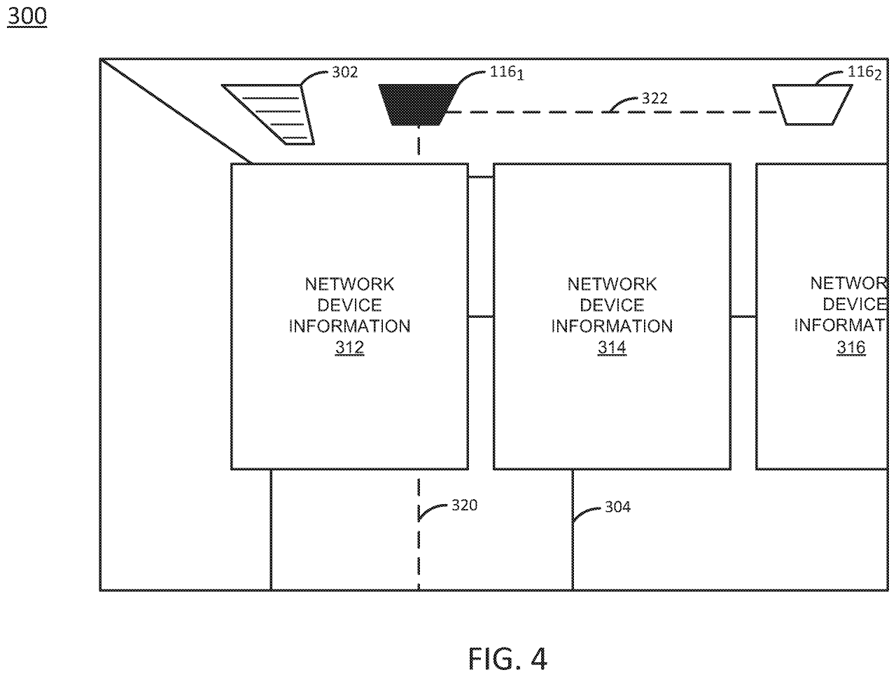

FIGS. 3 and 4 illustrate different views of a VR GUI 300 of the present disclosure. The VR GUI 300 represents a replica of a physical location 110, 112, or 114, as noted above. In the example illustrated in FIG. 3, the VR GUI 300 may represent a particular office in the location 110.

The VR GUI 300 may accurately display an arrangement of office furniture, desks, movable objects (e.g., trash cans, plants, water coolers, etc.), office equipment (e.g., copiers, multi-function devices, etc.), arrangement and location of network devices 116₁-116₄, and the like. In addition, the VR GUI 300 displays non-network devices or physical structures such as vents 302, walls 304, windows 308, doorways 310, and the like. As a result, a user wearing a head mounted display of the VR system 108 may see the exact three-dimensional (3D) replica of a location 110, 112, or 114 as if the user were actually at the location.

In one example, the VR GUI 300 may provide an interface that allows a plurality of different non-click commands to be used to interact with the physical location and/or make selections. For example, the non-click commands may include hand gestures (e.g., swiping hands), voice commands, eye tracking (e.g., retinal focus detection), and the like, or any combinations thereof. As a result, the VR GUI 300 allows a user to quickly access information and troubleshoot network devices 116₁-116₄ In one example, the network devices 116₁-116₄ may be a subset of all of the network devices 116₁-116ₙ that are associated with the location 110. Thus, the VR GUI 300 may display those network devices 116₁-116₄ that would be within the user's field of view if the user were physically present at the location 110 and looking in the same direction.

In one example, the user may use a non-click command (e.g., hand gestures) to swipe through different performance parameters in a display 306 and select a desired performance parameter to monitor. In one example, selecting the performance parameter may cause the NMS server 104 to enable the monitoring associated with the performance parameter. The NMS server 104 may find the data in the various file locations within the NMS server 104 to monitor the network devices 116₁-116ₙ. In one example, the display 306 may also allow a user to select a particular type of network device as well as the performance parameter. For example, the user may select a performance parameter of a packet drop rate for a network device type of routers.

In addition, the NMS server 104 may display the status of the network devices 116₁-116₄ in the VR GUI 300. For example, a color coding may be used to visualize the status of the network devices 116₁-116₄. For example, a red color may indicate that a network device 116 is malfunctioning based on the performance parameter that is selected. A green color may indicate that a network device 116 is operating properly based on the performance parameter that is selected.

In addition, the VR GUI 300 may display which network devices 116₁-116₄ are connected to which other network devices 116₁-116₄. For example, the connections may be displayed as dashed lines 320 and 322. In the example of FIG. 3, the network device 116₁ may be connected to network device 116₂ and 116₃. Thus, the user may quickly gather information associated with the network device 116₁ without having to perform any clicks or search through various file directories or menus. Further, the user may easily follow the dashed lines 320 and 322 to retrieve information about the connected network devices 116₂ and 116₃ via non-click actions without performing any clicks or searches through hierarchical file directories or menus.

In other words, the VR GUI 300 allows a user to select a performance parameter in the display 306 and then simply observe the states (which can be visually presented in different colors) of the network devices 116₁-116₄. The user is not required to click through a series of menus and file directories to locate the particular network devices 116₁-116₄, collect information on different screens associated with the network devices 116₁-116₄, and determine whether the network devices 116₁-116₄ are operating properly. Rather, the VR GUI 300 provides an intuitive interface that allows a user to simply select a performance parameter and observe multiple network devices 116₁-116₄ concurrently to determine if they are operating properly.

In addition, the VR GUI 300 may allow a user to use a single non-click action (e.g., hand gesture, eye movement, voice command, and the like) to concurrently retrieve network device information 212 of multiple network devices 116₁-116₄ within a certain distance of a particular network device 116 and within the user's field of view. The distance associated with the user's field of view can also be adjusted by a non-click action.

In one example, the NMS server 104 may determine that the network device 116₁ is malfunctioning based on a selected performance parameter. The NMS server 104 may cause the network device 116₁ to appear red (shown as a greyed out in FIG. 3).

As noted above, the VR GUI 300 may display physical structures that may provide context for the network devices 116₁-116₄. For example, a user viewing the VR GUI 300 may see that the network device 116₁ is near an air conditioning vent 302. The vent 302 may be continuously blowing cold air on the network device 116₁ that may negatively affect the performance of the network device 116₁. In addition, the wall 304 may block or interfere with transmission of signals to other network devices that may be located behind the wall 304. Thus, a user may troubleshoot the malfunctioning network device 116₁ by simply viewing where the network device 116₁ is located. Notably, this information may not be available on the NMS server 104 without the VR GUI 300.

In one example, the user may want to view the network device information associated with the network device 116₁. Thus, the user may simply focus on the network device 116₁ to select the network device 116₁. The head mounted display may have retinal detection and determine that the user's retina is focused on the network device 116₁. In response, a signal may be sent to the NMS server 104 and the NMS server 104 may provide a filtered view of the VR GUI 300 illustrated in FIG. 4.

In one example, focusing on the network device 116₁ may cause the VR GUI 300 to zoom into the selected network device 116₁. As shown in FIG. 4, the network device 116₁ appears larger as if the user walked closer to take a closer look. In another example, the network device 116₁ may appear disproportionally larger relative to other surrounding physical structures to bring the user's attention to the network device 116₁. In addition, based on the selection of the network device 116₁ all of the network device information 312, 314, and 316 may be displayed in the VR GUI 300 simultaneously. Notably, there are no size restrictions in the VR GUI 300. As a result, all of the network device information 312, 314, and 316 may be displayed in a single display or separate displays in the VR GUI 300. The user may simply move his or her hand, eye, and/or head to view the network device information 312, 314, and 316. For example, the network device information 316 may be cut off in the current view of FIG. 4. However, the user may simply turn his head to the right to read the entirety of the network device information 316.

In one example, the network device information 312 may be located in one file location in the NMS server 104, the network device information 314 may be located in a second different location in the NMS server 104, and the network device information 316 may located in a third different location in the NMS server 104. Without the VR GUI 300, the user may be required to know the location of each network device information 312, 314, and 316 within a series of menus or a large file directory. However, with the VR GUI 300, the user may simply focus on the network device 116₁ to select the network device 116₁ and all of the associated network device information 312, 314, and 316 may be automatically displayed in the VR GUI 300 at the same time.

Thus, with all of the network device information 312, 314, and 316, a view of the network device 116₁ relative to physical structures (e.g., the vent 302, the wall 304, and the like), and the visible connections of the network devices 116₁-116₄, the user may quickly troubleshoot any network device malfunction. In one example, a menu may be provided to allow a user to issue trouble shooting commands back to the NMS server 104 from within the VR GUI 300. The commands may include changing a value of a configuration parameter of the network device 116, initiating a reboot sequence, and the like. The NMS server 104 may then relay the command to the selected network device 116 over the IP network 102.

In one example, the network device information 312, 314, and 316 may indicate that the network device 116₁ is malfunctioning due to a connection to a network device at a different location (e.g., network device 118₁ at location 112). A user may issue a voice command to “transport” to the location 112 having the network device 118₁. In response, the NMS server 104 may transmit the VR GUI 300 associated with the location 112 having the network device 118₁. The user may select the network device 118₁, see the physical structures at the location 112, and view all of the network device information associated with the network device 118, as described above.

In addition, the user may call up the display 306 and swipe to the left or right with his or her hand to select a different performance parameter. When a different performance parameter is selected, the NMS server 104 may automatically change the color coding of the network devices 116₁-116₄ in the VR GUI 300. Thus, the user may then see a different network device 116 that is color coded red and troubleshoot the network device 116 in the VR GUI 300, as described above.

Thus, the VR GUI 300 of the present disclosure may allow a user to easily troubleshoot malfunctioning network devices by traveling to any location of any network device. In addition, the user may interact with the VR GUI 300 without any “clicks” (e.g., clicking a button, typing a key, and the like). Rather, the user may use non-click commands to interact with and make selections within the VR GUI 300 without having any knowledge of the file directory structure or menus of the NMS server 104.

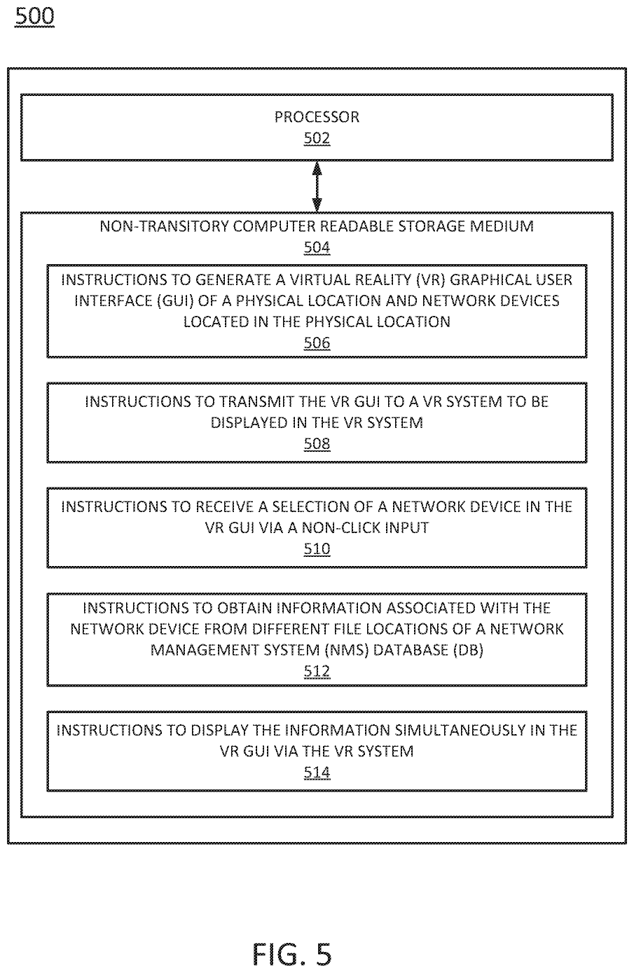

FIG. 5 illustrates an example of an apparatus 500. In an example, the apparatus 500 may be the NMS server 104 illustrated in FIG. 1. In an example, the apparatus 500 may include a processor 502 and a non-transitory computer readable storage medium 504. The non-transitory computer readable storage medium 504 may include instructions 506, 508, 510, 512, and 514 that, when executed by the processor 502, cause the processor 502 to perform various functions.

In an example, the instructions 506 may include instructions to generate a virtual reality (VR) graphical user interface (GUI) of a physical location and network devices located in the physical location. In one example, the VR GUI may be generated based on physical location information and network device information associated with network devices at the physical location.

The instructions 508 may include instructions to transmit the VR GUI to a VR system to be displayed in the VR system. In one example, the VR GUI may be transmitted by an NMS server over a wired or wireless communication path established over an IP network. The VR GUI may be displayed on a head mounted display of the VR system. The VR GUI may provide an exact replica of the physical location including the network devices and any non-network devices or physical structures. As a result, the user may see where the network devices are located in the physical location and where the network devices are located relative to physical structures and other network devices in the physical location.

The instructions 510 may include instructions to receive a selection of a network device in the VR GUI via a non-click input. The VR system may allow the user to interact with the VR GUI using non-click inputs, as described above. For example, the user may use hand gestures, voice commands, retinal focus, and the like.

The instructions 512 may include instructions to obtain information associated with the network device from different file locations of a network management system (NMS) database (DB). For example, the NMS server may locate network device information associated with the network device that is selected from all of the various file directory locations and/or menus in the NMS server.

The instructions 514 may include instructions to display the information simultaneously in the VR GUI via the VR system. The network device information may be displayed within the VR GUI at the same time. Thus, the user can view all of the network device information without having to click through a series of file directors or menus within the NMS server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a memory to store network device information and physical location information of a plurality of network devices;
a network device monitor to monitor a performance of network devices;
a virtual reality (VR) graphical user interface (GUI) generator to generate a VR GUI of a physical location that includes at least one of the plurality of network devices based on the physical location information and the network device information;
a communication interface to transmit the VR GUI to a VR system; and
a processor communicatively coupled to the memory, the network device monitor, the VR GUI generator, and the communication interface to provide the network device information via the communication interface to be displayed on the VR GUI in response to a non-click input received from the VR system.

2. The apparatus of claim 1, wherein the physical location in the VR GUI includes physical structures to provide positional context of the plurality of network devices in the physical location.

3. The apparatus of claim 1, wherein the VR GUI displays a subset of the plurality of network devices that are connected to a network device in the physical location.

4. The apparatus of claim 1, wherein operating network devices are shown in green in the VR GUI.

5. The apparatus of claim 1, wherein malfunctioning network devices are shown in red in the VR GUI.

6. The apparatus of claim 1, wherein the non-click input comprises a retinal focus that is detected to select of a network device in the VR GUI.

7. The apparatus of claim 6, wherein the network device information comprises all of the network device information associated with the network device displayed simultaneously in the VR GUI.

8. The apparatus of claim 1, wherein the non-click input comprises a swipe of a hand to select a parameter to monitor the performance of the network devices.

9. The apparatus of claim 1, wherein the non-click input comprises a voice command to select the physical location.

10. A non-transitory computer readable storage medium encoded with instructions executable by a processor, the non-transitory computer-readable storage medium comprising:
instructions to generate a virtual reality (VR) graphical user interface (GUI) of a physical location and network devices located in the physical location;
instructions to transmit the VR GUI to a VR system to be displayed in the VR system;
instructions to receive a selection of a network device in the VR GUI via a non-click input;
instructions to obtain information associated with the network device from different file locations of a network management system (NMS) database (DB); and
instructions to display the information simultaneously in the VR GUI via the VR system.

11. The non-transitory computer readable storage medium of claim 10, wherein the VR GUI includes physical structures to provide positional context of the network devices in the physical location.

12. The non-transitory computer readable storage medium of claim 10, further comprising:
instructions to store a plurality of tags associated with different physical locations.

13. The non-transitory computer readable storage medium of claim 10, further comprising:
instructions to receive a voice command from the VR system to view a different physical location;
instructions to generate the VR GUI of the different physical location and network devices in the different physical location based on a tag that matches the voice command; and
instructions to transmit the VR GUI of the different physical location associated with the tag to the VR system.

14. The non-transitory computer readable storage medium of claim 10, wherein the VR GUI displays a subset of network devices that are connected to a network device in the physical location.

15. The non-transitory computer readable storage medium of claim 10, wherein the information is displayed in the VR GUI adjacent to the network device that is selected.

16. The non-transitory computer readable storage medium of claim 10, wherein the network device that is selected in the VR GUI is a malfunctioning network device that is detected by a network device performance monitor.

17. The non-transitory computer readable storage medium of claim 10, wherein the network device is color coded as malfunctioning in the VR GUI.

18. A virtual reality (VR) graphical user interface (GUI), comprising:
a replica of a physical location including physical structures and a plurality of network devices;
a color coding of the plurality of network devices based on a performance of the plurality of network devices compared to a performance parameter;
a plurality of non-click commands to interact with the physical location and select the performance parameter; and
a simultaneous display of all information associated with a network device that is selected via a non-click command of the plurality of non-click commands.

19. The VR GUI of claim 18, wherein the plurality of network devices are located in the replica of the physical location in an identical position relative to the physical structures as in an actual physical location.

20. The VR GUI of claim 18, wherein connection lines are displayed between connected network devices.
